(19) United States
(12) Patent Application Publication
(10) Pub. No.: US 2026/0233851 A1
(43) Pub. Date: Aug. 13, 2026

(54) METHOD FOR MONITORING AND PROTECTING AN ELECTRICAL HYBRIDISATION SYSTEM AGAINST THE RISK OF FIRE

(71) Applicant: SAFRAN ELECTRICAL & POWER, Blagnac (FR)

(72) Inventors: Pierre RAVEL, Blagnac (FR); Li LI, Blagnac (FR); Philippe DELBOSC, Blagnac (FR); Benoît Lucien MICHAUD, Blagnac (FR); Guillaume PERCHERON, Blagnac (FR); Raouf BENLAMINE, Blagnac (FR)

(73) Assignee: SAFRAN ELECTRICAL & POWER, Blagnac (FR)

(21) Appl. No.: 19/153,529

(22) PCT Filed: Feb. 1, 2024
(86) PCT No.: PCT/FR2024/050134

§ 371 Date: Aug. 4, 2025

(30) Foreign Application Priority Data
Feb. 7, 2023 (FR) FR2301132

(51) Int. Cl. B64D 45/00; H02H 3/10; H02P 5/74; H02P 23/14

(52) U.S. Cl. CPC B64D 45/00; H02H 3/10; H02P 5/74; H02P 23/14; B64D 2045/009

(57) ABSTRACT

A method for protecting an electrical hybridisation system, the electrical hybridisation system including two rotary machines, each having at least one stator winding, each stator winding being associated with an AC-to-DC converter, and a distribution box for delivering, on the basis of DC voltages delivered by the AC-to-DC converters, a high DC voltage, on the one hand for local loads and on the other hand for the electrical network of an aircraft, in which method, current and voltage measurements are carried out in the distribution box, the converters and the stator windings of the rotary machines and if, once these measurements are consolidated together in a control card, the risk of fire is determined, the contactors of the distribution box and/or of the converters are selectively opened and the rotary machines are mechanically disconnected.

### TECHNICAL FIELD

The present invention relates to the field of protection systems for electrical distribution networks in electric or hybrid propulsion aircraft and, more specifically, concerns a method for monitoring and protecting an electrical hybridisation system ensuring full coverage of faults able to present a fire risk.

### PRIOR ART

Climate change is a major concern for many legislative and regulatory bodies around the world. Indeed, various restrictions on carbon emissions have been, are being or will be adopted by various states. In particular, an ambitious standard applies both to new types of aircraft and to those currently in circulation, requiring the implementation of technological solutions to bring them into line with current regulations. Civil aviation has now been working for several years to make its contribution to the fight against climate change.

Technological research efforts have already enabled significant improvements in the environmental performance of aircraft. The Applicant takes into account the impacting factors in all phases of design and development in order to obtain aeronautical components and products that consume less energy, are more environmentally friendly and whose integration and use in civil aviation has a moderate environmental impact, with the aim of improving aircraft energy efficiency.

As a result, the Applicant is constantly working to reduce its impact on the climate by using virtuous development and manufacturing methods and processes that minimise greenhouse gas emissions as much as possible in order to reduce the environmental footprint of its activities.

This sustained research and development work is focused on new generations of engines, making aircraft lighter, in particular through the materials used and lighter on-board equipment, developing the use of electrical technologies for propulsion, and, as an essential complement to technological progress, aeronautical biofuels.

Traditional protection principles for electrical networks and systems are based on simple, mainly passive devices. The protection systems mainly protect the electrical installation (not the equipment) according to the thermal behaviour of the cables and very locally according to a differential mode for detecting cable disconnections. In addition to the distribution, there is also generator protection based on the thermal behaviour of the generator windings and the dynamic behaviour of the voltage, in order to remain within the acceptable envelope for loads (common failure mode that can lead to catastrophic events).

However, in existing distribution systems, each line is connected by a switching element, contactor or static switch (SSPC), to the high voltage direct current (HVDC) busbar, and faults will be detected by a set of current sensors, with protection provided by opening the line.

The monitoring and protection of an electrical system are therefore well known and widespread in aircraft electrical distribution systems, but until now these have been operated at moderate voltages (<230 VAC) and with only one source connected at a time (apart from some 28 VDC systems).

In electrical hybridisation systems for aircraft turbomachines, the voltage of the electrical network is a DC voltage and of order 800 VDC, typically between 540 and 1000 VDC, and the system is subject to the consequences of altitude. Indeed, with a high DC voltage, electrical faults can lead to much more energetic arcs than with low voltage or AC voltage, very quickly causing serious damage that can go as far as to cause an outbreak of fire, or an uncontrolled fire, which cannot be accepted as meeting the aircraft turbomachine certification requirements to which such an electrical hybridisation system is subject.

An electrical monitoring and protection system must therefore leave no fault uncovered and must act quickly to avoid dangerous damage but, at the same time, must not cause untimely shut-downs too frequently. In the event of a fault, as much equipment as possible must be kept available, and therefore connected, so as not to impair to severely the availability of the aircraft's turbomachine (engine).

For high voltage applications, the energies involved, the potential damage and the negative effect of altitude on the dielectric characteristics of the air, mean that traditional protection adapted to the thermal properties of cables is no longer acceptable because it is too slow. In addition, new protection requirements are needed to cover phenomena (such as electric arcs) which had no effect at low voltage but which become critical at high voltage.

### DISCLOSURE OF THE INVENTION

The present invention is therefore the result of technological research aimed at very significantly improving aircraft performance and, in this sense, contributes to reducing their environmental impact. Its main aim is to ensure coverage of all possible faults and verification of their consistency, in order to provide robust detection of these faults. Another aim is to guarantee rapid action in the event of faults, in order to avoid major or dangerous degradation and propagation to other parts of the turbomachine or to its connection with the aircraft.

These aims are achieved by a method for monitoring and protecting an electrical hybridisation system against the risk of fire, the electrical hybridisation system comprising two rotary machines, each having at least one stator winding, each stator winding being associated with an AC-to-DC converter, and a distribution box for delivering, on the basis of DC voltages delivered by the AC-to-DC converters, a high DC voltage, on the one hand for local loads and on the other hand for the electrical network of an aircraft, characterised in that current and voltage measurements are carried out in the distribution box, the converters and the stator windings of the rotary machines and if, once these measurements are consolidated together in a control card, the risk of fire is determined, the contactors of the distribution box and/or of the converters are selectively opened and the rotary machines are mechanically disconnected.

Through this principle of consolidating available measurements from existing sensors in the various pieces of equipment of the system, all zones are covered without the need for additional sensors. The high-voltage DC electrical installation is thus protected with a good level of expected performance, in particular in terms of reaction time and robustness, all achieved in a coherent manner.

Preferably, the measurement of an overcurrent or an overvoltage in the distribution box and/or the converters, or the detection of an excessive temperature or a low oil pressure in the rotary machines, causes the opening of the switches of the converters, the opening of the contactor of the distribution box, and then the mechanical disconnection of the rotary machine.

Advantageously, the measurement of an overcurrent at the output of the distribution box causes the opening of the contactor or of the static switch associated with the faulty local load and, in the event of a failure to open, the opening of all the contactors or static switches associated with the other local loads.

Preferably, the measurement of an overcurrent at an input on the converter side of the distribution box, causes the opening of the switches of this converter, followed by the opening of the contactor of the distribution box, and then, if necessary, the mechanical disconnection of the rotary machine.

Advantageously, the detection of an electric arc in one of the rotary machines causes the short-circuiting of the switches of the associated converter, and then the mechanical disconnection of the rotary machine.

Preferably, the detection of an electric arc on the aircraft electrical network causes the opening of the contactor of the distribution box.

Advantageously, the switches of the converters and of the distribution box are opened whenever a rotary machine is shut-down or is started up, or during its maintenance.

Preferably, the opening of the contactors and switches is defined by threshold and tripping duration parameters determined for each as a function of the configuration of the electrical network and the equipment characteristics of the electrical hybridisation system.

Advantageously, a disconnection test of the rotary machines is carried out periodically or whenever they are shut-down.

Preferably, the measurements of current and voltage, oil pressure and temperature are consolidated together in a management and processing module preferably located in the distribution box.

### BRIEF DESCRIPTION OF THE DRAWINGS

Other features and advantages of the present invention will become apparent from the description given below, with reference to the appended drawings which illustrate an exemplary embodiment that is in no way limiting and wherein:

FIG. 1 illustrates a first example of an electrical hybridisation system according to the invention,

FIG. 2 illustrates a second example of a electrical hybridisation system according to the invention,

FIG. 3 shows an integration diagram for measurements in the electrical hybridisation system of FIG. 1,

FIG. 4 shows an integration diagram for protections in the electrical hybridisation system of FIG. 1, and

FIG. 5 illustrates various protection zones monitored with the invention.

### DESCRIPTION OF THE EMBODIMENTS

The principle of the invention is based on in-depth knowledge and monitoring of the various pieces of equipment in the electrical hybridisation system, in order to improve protection of the system. While the components remain conventional compared with those used in electrical protection, such as contactors and static switches, or mechanical disconnection systems for rotary machines, their tripping is determined with greater precision and selectivity, on the one hand, and with more global consolidation and/or cross-referencing algorithms, on the other.

The measurements made in the various pieces of equipment are consolidated and the cross-checking of current and voltage measurements helps to refine fault detection Knowing the measurements and the state of the system, in particular the open or closed state of the switches, enables global validations to be added, such as current summations.

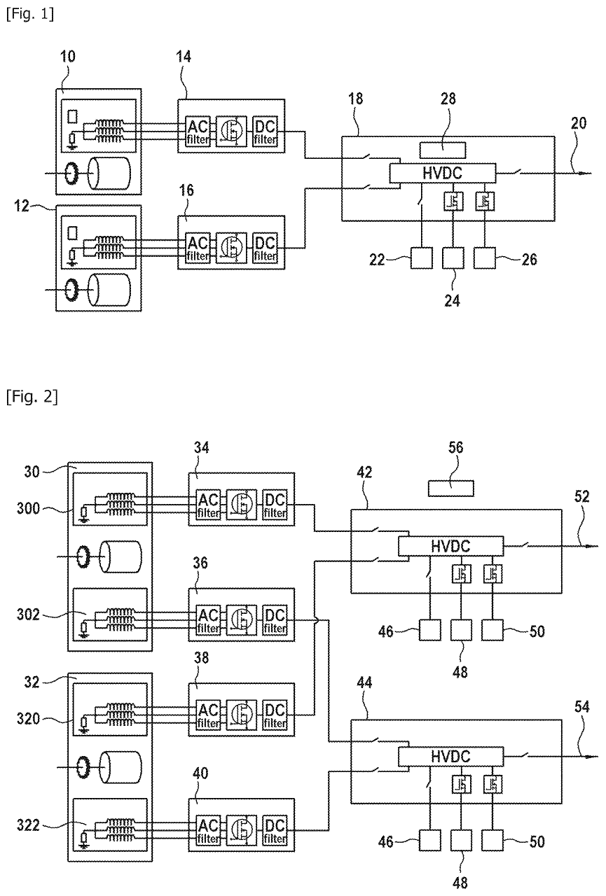

FIG. 1 illustrates a first example of an electrical hybridisation system in accordance with the invention, consisting of two rotary machines 10, 12, possibly of the PMG (Permanent Magnet Generator) type, two electronic AC-to-DC converters (Power Electronics-PE) 14, 16 respectively associated with these rotary machines, a PDMU (Power Distribution Management Unit) type distribution box 18, the bipolar HVDC (High Voltage Direct Current) distribution busbar of which is connected, on the one hand, to the converters and, on the other hand, to the aircraft electrical network 20 and to local loads 22, 24, 26, for example.

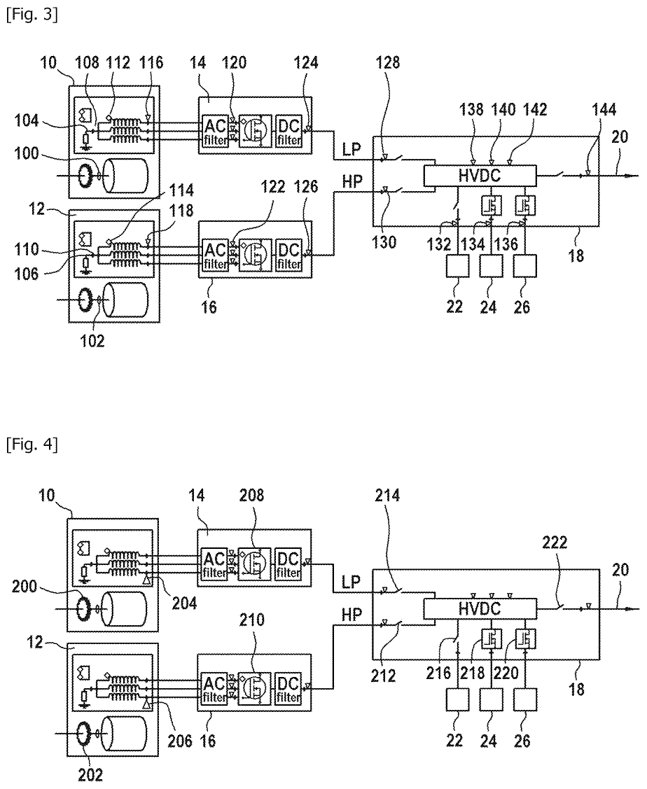

The electrical hybridisation system is equipped with sensors, some of which are necessary for the operation of the system (voltage regulation and power control in the converters), while others have been added specifically to detect faults in the system. The sensors installed at various points in the system provide current measurements, voltage measurements, insulation measurements, arc detections, temperature measurements, oil pressure measurements, and measurements of the position and speed of the rotors of the rotary machines. These are described in more detail in FIG. 3.

The electrical hybridisation system is also fitted with electrical protection devices that open the faulty line or lines, for example to stop the flow of a faulty current and/or to isolate a dangerous voltage. Additional protection may consist of mechanically disconnecting the rotor of the rotary machine from its drive (by uncoupling or disengaging) in order to stop it rotating. The protections are incorporated either in the distribution box, or in the converters, or in the rotary machines and will be described in more detail in conjunction with FIG. 4.

The definition of the electrical protections, by means of threshold and duration parameters, ensures selectivity among the protections, and is determined as a function of the configuration of the electrical network and the characteristics of the equipment of the electrical hybridisation system. The control of these electrical protections may be distributed throughout the system, or even be external to the turbomachine, but it is preferably disposed in the distribution box 18 which comprises a control card 28 for monitoring and protecting the system according to the invention.

FIG. 2 shows another example of an electrical hybridisation system, also comprising two rotary machines 30, 32 of the PMG (permanent magnet generator) type, each with two stator winding channels 300, 302, 320, 322, four electronic AC-to-DC converters (power electronics) 34, 36, 38, 40 respectively associated with four stator windings of the two rotary machines, two PDMU (power distribution management unit) distribution boxes 42, 44, local loads 46, 48, 50 and two output connections 52, 54 to the aircraft electrical network. A control card 56 for monitoring and protecting the system may be located in one or both of the distribution boxes or, as illustrated, outside of these.

FIG. 3 illustrates the set of measurement sensors disposed in the various pieces of equipment in the electrical hybridisation system of FIG. 1. Reference signs 100, 102 correspond to a first sensor, providing a measurement of the position or speed of the rotor in each of the two rotary machines 10, 12. Reference signs 104, 106 correspond to a second sensor, providing either a measurement of the current in the connection of the neutral to ground through an impedance in each of the two rotary machines 10, 12, or a measurement of the voltage across this impedance connecting the neutral to ground. Reference signs 108, 110 correspond to a third sensor, providing, if necessary, a measurement of the imbalance current between the two star circuits in parallel, in each of the two rotary machines 10, 12. Reference signs 112, 114 correspond to a fourth sensor, providing a measurement of the temperature of the stator windings in each of the two rotary machines 10, 12. Reference signs 116, 118 correspond to a fifth sensor, providing a measurement of the currents in the phases of the stator windings in each of the two rotary machines 10, 12. Reference signs 120, 122 correspond to a sixth sensor, measuring the phase currents and voltages between the phases on the AC side, at the input of the electronic converters 14, 16. Reference signs 124, 126 correspond to a seventh sensor, measuring the currents and voltages on the DC side, at the output of the electronic converters 14, 16. Reference signs 128, 130 correspond to an eighth sensor, measuring the currents and voltages at the input of the distribution box 18. Reference signs 132, 134, 136 correspond to a ninth sensor, measuring the currents at each of the inputs of the local loads 22, 24, 26. Reference 138 corresponds to a tenth sensor, measuring the voltage on the high voltage direct current (HVDC) distribution busbar of the distribution box 18. Reference sign 140 corresponds to an eleventh sensor, providing an insulation measurement (denoted “IMD”), connected to the HVDC busbar. This measurement may optionally also be made only during maintenance by an external device. Reference sign 142 corresponds to a twelfth sensor, providing a temperature measurement on the high voltage direct current distribution busbar and reference sign 144 corresponds to a thirteenth sensor, providing a current and voltage measurement, and arc detection at the output of the distribution box 18 to the electrical network of the aircraft 20.

FIG. 4 illustrates the set of protections disposed in the various pieces of equipment in the electrical hybridisation system of FIG. 1. Reference signs 200, 202 correspond to a mechanical disconnection device in each of the two rotary machines 10, 12. Reference signs 204, 206 correspond to an opening in the AC phase lines in each of the two rotary machines (alternatively, this opening could be made at the input of the two electronic converters 14, 16). Reference signs 208, 210 correspond to the electronic switches used for protection of the electronic converters 14, 16. Reference signs 212, 214 correspond to a contactor for each of the inputs of the distribution box 18. Reference sign 216 corresponds to a contactor for the local load 22. Reference signs 218, 220 correspond to electronic switches, of the SSPC type, for each of the local loads 24, 26 and reference sign 222 corresponds to a contactor on the connection with the aircraft electrical network 20.

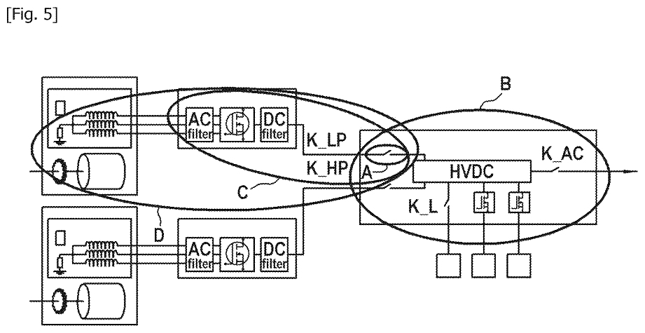

In order to define a protection strategy without having to add sensors or protections to the electrical hybridisation system, it is proposed to combine the information available through a measurement and processing operating member, in order to carry out the monitoring and protection functions necessary to correctly protect the system with good levels of detection, localisation and isolation of the fault, quickly and robustly, before it has time to create significant damage. To achieve this, and as shown in FIG. 5, the electrical hybridisation system is separated into four distinct protection zones corresponding to four different types of consolidation. The first is carried out on the perimeter of the contactor 212, 214, forming the protection component of the distribution box 18 and corresponds to so-called type A consolidation. The second is carried out on the perimeter formed by the distribution box 18 in its entirety and corresponds to a so-called type B consolidation. The third is carried out on the perimeter of the electronic converter 14, 16 and the associated protection component (contactor 212, 214) in the distribution box 18 and corresponds to a so-called type C consolidation. The fourth is carried out on a wide perimeter grouping together the rotary machine 10, 12 and its associated electronic converter 14, 16, as well as the associated protection component 212, 214 in the distribution box 18 and corresponds to a so-called type D consolidation.

### Type A: Electrical Signal Characteristics:

All the equipment in the electrical hybridisation system is known, so the only lack of visibility is the connection to the electrical network of the aircraft. The electrical characteristics of the currents and voltages associated with the equipment are used to adjust the thresholds and tripping times of the protections, and to add frequency or harmonic analyses where relevant. The current-time curves of the protection devices on the input lines in the distribution box are adjusted in relation to the output characteristics of the converters when they are in generator mode or motor mode, depending on the configuration of the network, and in relation to their power limitations, and not just on the heating characteristics of the cables.

### Type B: Internal Consolidation of the Distribution Box:

The distribution box is a node in the network, with few internal losses (Joule losses and power taken by the internal supply), and no large capacitor on the high-voltage DC busbar. The algebraic sum of the currents entering and leaving the distribution box must therefore be virtually zero at all times. A significant deviation from this sum of currents would indicate a serious internal fault or a current sensor fault. An example of a protection condition can be given by the following formula:

$$If ABS ( Current\_converter A + Current\_converter B + Current\_AC + Current\_load A + Current\_load B … ) > threshold$$

### Then Fault

### Type C: Consolidation by Coherence Between the Converter and the Distribution Box and Between the Converter and the Rotary Machine:

The measurements in the distribution box and those at the output of the converters are compared. The currents of the positive and negative poles and the differential voltage must be identical (for the voltage plus or minus the cable voltage drop, which is very small). If there is a discrepancy, this indicates a problem on the line between the two pieces of equipment or a sensor fault. In both cases, the line must be opened. An example of a protection condition can be given by the formula:

| | |
|---|---|
| If | ABS (I_pole +_distribution box − I_pole +_converter) > |
| | threshold |
| Or | ABS (I_pole −_ distribution box − I_pole −_ converter) > |
| | threshold |
| Or | ABS (V_distribution box − V_converter) > threshold |
| Then | Fault |

Type D: Consolidation with the Measurements Implemented in the Rotary Machine:

The winding of the rotary machine incorporates current transformers, for which measurements are carried out in the associated converter, with the advantage that these transformers provide a measurement isolated from the power circuit. The current transformers are placed on each phase and on the connections of the neutrals connected via a resistance to ground.

Measuring the current in the neutral conductor provides an almost direct measurement of the current flowing in an insulation fault, and as the current transformer is dedicated, its characteristics are defined so that measurement can be made with good accuracy. Fault detection using the current flowing in the neutral connection also takes account of the frequency of the ripples in the neutral connection to identify where the fault is located, in the first rotary machine and the AC wiring connected to it, or in the second rotary machine and its AC wiring, or in a DC connection.

The following tables illustrate the detailed application of the protection system to an electrical hybridisation system. Each table lists, for each protection device, the faults it protects against, the measurements it uses to detect them, and the action it takes. In addition, the possible consolidation to confirm or invalidate a measurement, and the possible test of the protection device, according to the four types of consolidation defined above, are given.

| | | | | Check of the availability of protection | | |
|---|---|---|---|---|---|---|
| | Protections | | | | | Test of the |
| | | Detection - | Protective | Consolidation of | Type of | protective |
| Component | Fault | measurement | action | measurements | consolidation | device |
| Contactor | Overload | Pos current at | Opening of | With the Pos | A, B, C | Openings of |
| K_LP | Current delta | the input LP_PE | LP_PE | current at the | | K_LP and |
| | Positive | Neg current at | then opening | output on the DC | | LP_PE each |
| | (Pos)- | the input LP_PE | of K_LP | side of the LP_PE | | time the |
| | Negative | | | With the other | | engine is shut- |
| | (Neg) | | | current | | down or |
| | | | | measurements in | | started up, or |
| | | | | the PDMU | | during |
| | Undervoltage | Pos-Neg voltage | | With the Pos-Neg | C | maintenance |
| | Overvoltage | at the input | | voltage at the | | |
| | | LP_PE | | output on the DC | | |
| | | | | side of the LP_PE | | |
| | Internal | Contactor status | | Correlation | B | |
| | indication | feedback | | between control | | |
| | failure | | | and current | | |
| | | | | measurement | | |
| Contactor | Overload | Pos current at | Opening of | With the Pos | A, B, C | Opening of |
| K_HP | Pos-Neg | the input HP_PE | HP_PE | current at the | | K_HP and |
| | current delta | Neg current at | then opening | output on the DC | | HP_PE each |
| | | the input HP_PE | of K_HP | side of the HP_PE | | time the |
| | | | | With the other | | engine is shut- |
| | | | | current | | down or |
| | | | | measurements in | | started up, or |
| | | | | the PDMU | | during |
| | Undervoltage | Pos-Neg voltage | | With the Pos-Neg | C | maintenance |
| | Overvoltage | at the input | | voltage at the | | |
| | | HP_PE | | output on the DC | | |
| | | | | side of the HP_PE | | |
| | Internal | Contactor status | | Correlation | B | |
| | indication | feedback | | between control | | |
| | failure | | | and current | | |
| | | | | measurement | | |
| Contactor | Overload | Pos current at | Opening of | With the currents | A, B | Opening of |
| K_AC | Pos-Neg | the Aircraft | K_AC | in K_LP and | | K_AC each |
| | current delta | output | | K_HP | | time the |
| | | Neg current at | | | | engine is shut- |
| | | the Aircraft | | | | down or |
| | | output | | | | started up, or |
| | Undervoltage/ | Pos-Neg voltage | | With the other | B | during |
| | Overvoltage | at the Aircraft | | voltage | | maintenance |
| | | output | | measurements in | | |
| | | | | the PDMU | | |
| | Arc | Current and | | | A | |
| | | voltage for arc | | | | |
| | | detection (AFD) | | | | |
| | Internal | Contactor status | | Correlation | B | |
| | indication | feedback | | between control | | |
| | failure | | | and current | | |
| | | | | measurement | | |
| Contactor | Overload | Pos or Neg | Opening of | With the currents | B | Opening of |
| K_L | Delta Pos- | currents at the | K_L | in K_LP and | | K_L each time |
| | Neg | output L | | K_HP | | the engine is |
| | Undervoltage/ | Pos-Neg voltage | | With the other | B | shut-down or |
| | Overvoltage | at Icing1 output | | voltage | | started up, or |
| | | | | measurements of | | during |
| | | | | the PDMU | | maintenance |
| | Internal | Contactor status | | Correlation | B | |
| | indication | feedback | | between control | | |
| | failure | | | and current | | |
| | | | | measurement | | |
| HVDC busbar | Undervoltage/ | Pos-Neg voltage | Opening of | With the other | B | Opening of the |
| | Overvoltage | on the internal | LP_PE and | voltage | | contactors and |
| | | HVDC busbar | HP_PE | measurements of | | SSPC of the |
| | | | then opening | the PDMU | | PDMU and |
| | High | Temperature on | of all the | Correlation | B | LP_PE and |
| | temperature | the internal | contactors of | between control | | HP_PE each |
| | of the internal | HVDC busbar | the PDMU | and current | | time the |
| | HVDC busbar | | | measurement, and | | engine is shut- |
| | | | | with the other | | down or |
| | | | | temperatures | | started up, or |
| | | | | | | during |
| | | | | | | maintenance |
| | Pos insulation | Pos-Ground | Maintenance | With the currents in | B, D | |
| | fault | insulation measured | alert | the Neutral-Ground | | |
| | | by IMD device | | connections of the | | |
| | | Pos-Ground | | windings LPMG | | |
| | | voltage on the | | and HPMG | | |
| | | internal HVDC | | | | |
| | | busbar | | | | |
| | Neg insulation | Neg-Ground | | With the currents in | B, D | |
| | fault | insulation measured | | the Neutral-Ground | | |
| | | by IMD device | | connections of the | | |
| | | Neg-Ground | | windings LPMG | | |
| | | voltage on the | | and HPMG | | |
| | | internal HVDC | | | | |
| | | busbar | | | | |
| SSPC switch | Overload | Pos or Neg | Opening of | With K_LP and | B | Opening of |
| loads | Pos-Neg | currents at the | K_L | K_HP currents | | K_L each time |
| | current delta | output L | | | | the engine is |
| | | | | | | shut-down or |
| | | | | | | started up, or |
| | | | | | | during |
| | | | | | | maintenance |
| | Overload | | Melting of the | With the Pos or | B | |
| | fuses | | fuse | Neg current in the | | |
| | | | | SSPC | | |

The analysis is similar for the two LP and HP systems, each consisting of the PMG machine and the associated PE converter. The following tables refer generically to “PMG” and “PE”.

| | Protections | | | Check of the availability of protection | | |
|---|---|---|---|---|---|---|
| | | Detection - | Protective | Consolidation | Type of | device test |
| Component | Fault | measurement | action | of measurements | consolidation | Protective |
| PMG and | Overload | Currents of | Control or | With the | D, C | Test of the |
| PE | Unbalanced currents | the Phases at | opening of | currents of the | | disconnection |
| | | the output of | the MOS | Phases at the | | system of the |
| | | the PMG | switches of | input of the | | PMG when |
| | | | the PE | inverter of PE | | the engine is |
| | Unbalanced currents | Current | then | With the current | D | shut-down or |
| | between star | between | opening of | in the Neutral- | | in |
| | circuits 1/2 | Neutral1- | the PDMU | Ground | | maintenance |
| | | Neutral2 | contactor | connection | | |
| | Overload | Pos current at | then | With the Pos or | C | Opening of |
| | Pos-Neg current | the DC output | mechanical | Neg currents at | | the PE each |
| | delta | of the PE | disconnection | the PE input of | | time the |
| | | | of the PMG | the PDMU | | engine is |
| | Undervoltage/ | Pos-Neg | | With the Pos- | C | shut-down or |
| | Overvoltage | voltage at the | | Neg voltage at | | started up, or |
| | | output DC of | | the PE input of | | during |
| | | the PE | | the PDMU | | maintenance |
| | Overload | Phase | | With the Phase | D | Opening of |
| | Unbalanced | currents at the | | currents at the | | the PE each |
| | currents | PE inverter | | PMG output | | time the |
| | | input | | | | engine is |
| | Undervoltage/ | Voltages | | | B | shut-down or |
| | Overvoltage | between | | | | started up, or |
| | Unbalanced | phases at the | | | | during |
| | voltages | inverter of the | | | | maintenance |
| | | PE | | | | Test of the |
| | High temperature | Winding | | Correlation with | D | disconnection |
| | | temperatures | | the phase | | system of the |
| | | | | currents | | PMG when |
| | High temperature | Oil | | Correlation with | D | the engine is |
| | | temperature | | the winding | | shut-down |
| | | | | temperatures | | |
| | Low oil pressure | Oil under- | | Correlation with | D | |
| | | pressure | | the oil | | |
| | | contact | | temperature | | |
| | Insulation fault | Current in the | Maintenance | Correlation with | D, C | N/A |
| | | Neutral- | alert | the IMD device | | |
| | | Ground | | in the PDMU | | |
| | | connection of | | | | |
| | | the winding | | | | |

Control of the protection system is best seen in the following table, which lists the faults likely to lead to a risk of fire, and the measurements and consolidations carried out to check the availability of the protection which will then be activated to avoid this risk.

| | | Consequence | | | | |
|---|---|---|---|---|---|---|
| | Main failure | of failure | | | Check of the | Allocation of |
| Failure | principles | without | | Protective | availability of | the |
| mode | covered | protection | Detection | action | protection | protection |
| On AC | Short-circuit | Fire due to | Overcurrent | Control or | The measurements | PDMU |
| circuits: | between | overheating | (measurements | opening of the PE | of PMG and PE | PE |
| Overload | phases in the | | in the PMG | switches | current are | PMG |
| and current | PMG, PE or | | and/or PE) | then opening of | consolidated | |
| imbalance | harnesses | | Or desaturation | the contactor in | together | |
| | | | of the | the PDMU | Opening of the | |
| | | | electronic | then mechanical | PE and PDMU | |
| | | | switches | disconnection of | switches each | |
| | | | | the PMG | time the engine is | |
| | | | | | shut-down or | |
| | | | | | started up, or | |
| | | | | | during | |
| | | | | | maintenance | |
| | | | | | Test of the | |
| | | | | | disconnection | |
| | | | | | system of the | |
| | | | | | PMG when the | |
| | | | | | engine is shut- | |
| | | | | | down | |
| DC: | Short-circuit | Fire | Overcurrent | Opening of the | Current | PDMU |
| Overload at | at the PDMU | | (measurement | switch associated | measurement at | |
| the PDMU | output (PDMU | | by the PDMU | with the PDMU | the output | |
| output | output, harness, | | after the | In the event of | consolidated with | |
| (loads) | load) | | associated | failure of the | the other current | |
| | | | switch) | switch, all the | measurements | |
| | | | | others are | and detection of | |
| | | | | commanded to open | undervoltage | |
| | | | | The SSPC lines | Opening of the | |
| | | | | have a fuse for | PDMU switches | |
| | | | | protection in the | each time the | |
| | | | | event of failure | engine is shut- | |
| | | | | | down or started | |
| | | | | | up, or during | |
| | | | | | maintenance | |
| DC: | Short-circuit | Fire | Overcurrent | Control or | PE current | PDMU |
| Overload at | at PDMU | | (measurement | opening of the | measurement | PE |
| PDMU input | input (PDMU | | by the PDMU | electronic | consolidated with | PMG |
| (sources) | input, | | before the | switches of the | the other current | |
| | harness, PE) | | associated | PE | measurements | |
| | | | switch) | then opening of | and detection of | |
| | | | | the corresponding | undervoltage | |
| | | | | contactor in the | Opening of the | |
| | | | | PDMU | PE and PDMU | |
| | | | | then mechanical | switches each | |
| | | | | disconnection of | time the engine is | |
| | | | | the PMG, if | shut-down or | |
| | | | | necessary | started up, or | |
| | | | | In the event of | during | |
| | | | | failure of the | maintenance | |
| | | | | contactor, all the | Disconnection | |
| | | | | others are | test of the PMG | |
| | | | | commanded to | | |
| | | | | open | | |
| Overvoltage | PE failure + | Overvoltage | Overvoltage | Control or | PE and PDMU | PDMU |
| | other failures | or | (PDMU or PE | opening of the | voltage | PE |
| | depending on | Fire due to | measurements) | electronic | measurements | PMG |
| | the control | insulation fault. | | switches of the | consolidated | |
| | architecture | | | PE | together | |
| | | | | then opening of | Opening of the | |
| | | | | the contactor in | PE and PDMU | |
| | | | | the PDMU | switches each | |
| | | | | then mechanical | time the engine is | |
| | | | | disconnection of | shut-down or | |
| | | | | the PMG, if | started up, or | |
| | | | | necessary | during | |
| | | | | | maintenance | |
| | | | | | Disconnection | |
| | | | | | test of the PMG | |
| External oil | Cracking of | Fire due to | Low oil | Control or | Dual oil- | PDMU |
| leak from the | the PMG | overheating of | pressure | opening of the PE | pressure | PE |
| PMG | casing, | the PMG and oil | | switches | measurement | PMG |
| | deterioration | leak (which | | then opening of | Opening of the | |
| | of the seal | could lead to an | | the contactor in | PE and PDMU | |
| | | external fire) | | the PDMU | switches each | |
| | | | | then mechanical | time the engine is | |
| | | | | disconnection of | shut-down or | |
| | | | | the PMG, if | started up, or | |
| | | | | necessary | during | |
| | | | | | maintenance | |
| | | | | | Disconnection | |
| | | | | | test of the PMG | |
| Overheating | Loss of bearing | Fire due to | Overheating | Control or | Winding an oil | PDMU |
| of the PMG | lubrication or | overheating of | (winding or oil | opening of the PE | temperatures | PE |
| | of cooling oil | the PMG | temperatures) | switches | consolidated | PMG |
| | Short-circuit | | | then opening of | Opening of the | |
| | in the PMG | | | the contactor in | PE and PDMU | |
| | . . . | | | the PDMU | switches each | |
| | | | | then mechanical | time the engine is | |
| | | | | disconnection of | shut-down or | |
| | | | | the PMG | started up, or | |
| | | | | | during | |
| | | | | | maintenance | |
| | | | | | Disconnection | |
| | | | | | test of the PMG | |
| leak from the | Insulation | Fire | IMD | Double | Consolidated | PDMU |
| HV to the | fault between | | Overvoltage | insulation to avoid | temperature | |
| internal | HV and | | on the 28VDC | faults | measurements in | |
| 28VDC at | 28VDC | | Overheating | Opening of the | the PDMU | |
| the PDMU | | | | switch on the 28 V | Opening of the | |
| | | | | of the PDMU | PDMU switches | |
| | | | | Opening of the | each time the | |
| | | | | HVDC switches | engine is shut- | |
| | | | | of the PDMU | down or started | |
| | | | | | up, or during | |
| | | | | | maintenance | |
| AC arc fault | Fault in the | Fire due to | Algorithm | Short-circuiting | Consolidation of | PE |
| | harness | electrical arcs | based on the | of the PE | the | PMG |
| | | and other | measurements | switches to lower | measurements in | |
| | | damage | of the PE | the voltage | the PMG and PE | |
| | | | | Mechanical | Disconnection | |
| | | | | disconnection of | test of the PMG | |
| | | | | the PMG | | |
| DC arc fault | Fault in the | Fire due to | Arc detection | Opening of | AFD measurements | PDMU |
| | harness | electrical arcs | device for the | K_AC | consolidated with | |
| | | and other | Aircraft line | for the other | other PDMU | |
| | | damage | | lines, indirect | measurements | |
| | | | | detection from | Opening of the | |
| | | | | voltage | PDMU switches | |
| | | | | | each time the | |
| | | | | | engine is shut- | |
| | | | | | down or started | |
| | | | | | up, or during | |
| | | | | | maintenance | |

In general, it should be noted that the invention can be applied to a system in motor (propulsion) or generator mode, in single-channel or multi-channel, and for both three-phase and multi-phase machines (with a number of phases >3), for machines with magnets (PMG) or wound rotor machines, with the electronic converter separate from the machine and connected by intermediate cabling, or on the contrary integrated or glued to it with very short electrical connections.

The invention can be applied to any electric hybridisation system installed in a carrier other than an aircraft, helicopter, VTOL, etc., as well as to an electric propulsion system combining several pieces of equipment.

1. A method for monitoring and protecting an electrical hybridisation system against the risk of fire, the electrical hybridisation system comprising two rotary machines, each having at least one stator winding, each stator winding being associated with an AC-to-DC converter, and a distribution box for delivering, on the basis of DC voltages delivered by the AC-to-DC converters and via an HVDC distribution busbar, a high DC voltage, on the one hand for local loads and on the other hand for the electrical network of an aircraft, the method being characterised in that current and voltage measurements are carried out in the distribution box, the converters and the stator windings of the rotary machines and if, once these measurements are consolidated together in a control card, the risk of fire is determined, the contactors of the distribution box and/or of the converters are selectively opened and the rotary machines are mechanically disconnected.

2. The monitoring and protection method according to claim 1, wherein the measurement of an overcurrent or an overvoltage in the distribution box and/or the converters, or the detection of an excessive temperature or a low oil pressure in the rotary machines, causes the opening of the switches of the converters, the opening of the contactor of the distribution box, and then the mechanical disconnection of the rotary machine.

3. The monitoring and protection method according to claim 1, wherein the measurement of an overcurrent at the output of the distribution box causes the opening of the contactor or of the static switch associated with the faulty local load and, in the event of a failure to open, the opening of all the contactors or static switches associated with the other local loads.

4. The monitoring and protection method according to claim 1, wherein the measurement of an overcurrent at an input on the converter side of the distribution box, causes the opening of the switches of this converter, followed by the opening of the contactor of the distribution box, and then, if necessary, the mechanical disconnection of the rotary machine.

5. The monitoring and protection method according to claim 1, wherein the detection of an electric arc in one of the rotary machines causes the short-circuiting of the switches of the associated converter, and then the mechanical disconnection of the rotary machine.

6. The monitoring and protection method according to claim 1, wherein the detection of an electric arc on the aircraft electrical network causes the opening of the contactor of the distribution box.

7. The monitoring and protection method according to claim 1, wherein the switches of the converters and of the distribution box are opened whenever a rotary machine is shut-down or started up, or during its maintenance.

8. The monitoring and protection method according to claim 1, wherein the opening of the contactors and switches is defined by threshold and tripping duration parameters determined for each as a function of the configuration of the electrical network and the equipment characteristics of the electrical hybridisation system.

9. The monitoring and protection method according to claim 1, wherein a disconnection test of the rotary machines is carried out periodically or each time they are shut-down.

10. The monitoring and protection method according to claim 1, wherein the measurements of current and voltage, oil pressure and temperature are consolidated together in a management and processing module.

11. The monitoring and protection method according to claim 10, wherein the management and processing module is disposed in the distribution box.
